(19) United States
(12) Patent Application Publication
(10) Pub. No.: US 2024/0338731 A1
(43) Pub. Date: Oct. 10, 2024

(54) ADVERTISEMENT EFFECT PREDICTION DEVICE

(71) Applicant: NTT DOCOMO, INC., Tokyo (JP)

(72) Inventors: Takahito ISHII, Chiyoda-ku (JP); Tsukasa DEMIZU, Chiyoda-ku (JP)

(73) Assignee: NTT DOCOMO, INC., Tokyo (JP)

(21) Appl. No.: 18/293,993

(22) PCT Filed: Jul. 27, 2022
(86) PCT No.: PCT/JP2022/028947

§ 371 Date: Jan. 31, 2024

(30) Foreign Application Priority Data
Sep. 7, 2021 (JP) 2021-145304

(51) Int. Cl. G06Q 30/0241; G06Q 30/0251

(52) U.S. Cl. CPC G06Q 30/0247; G06Q 30/0253; G06Q 30/0254

(57) ABSTRACT

An advertising effect prediction device includes: a construction unit that converts layout information of delivered manuscript into a graph structure through collation with a flow line of a user using a scheme related to a GNN, and performs machine learning using a feature quality of each node in the graph structure and delivery user attribute information as explanatory variables and a flag indicating presence or absence of a click of each delivery user based on delivery result as an objective variable to construct a prediction model for predicting click through rate of an individual user; and a prediction unit that converts the layout information into a graph structure using the same scheme based on target user attribute information and the delivered manuscript and inputs the feature quantity and the target user attribute information to a prediction model, to obtain click through rate prediction value of the individual user.

### TECHNICAL FIELD

The present disclosure relates to an advertising effect prediction device that predicts a click through rate of an individual user while considering a relationship between a plurality of pieces of content included in a delivered manuscript and user attribute information.

### BACKGROUND ART

In recent years, advertisement delivery systems that direct a user to a web page of an advertiser when the user accesses a web page via the Internet and clicks or taps on an advertisement posted on the web page (hereinafter collectively referred to as “clicks” for convenience) have been adopted. In such an advertisement delivery system, when a revenue expected at the time of posting of an advertisement is predicted, it is common to predict a click through rate (CTR), which is a probability that a user will click on the advertisement, and use a prediction value for profit prediction, and for example, a technology for predicting a click through rate for profit prediction has been proposed in

Patent Literature 1.

### CITATION LIST

### Patent Literature

[Patent Literature 1] Japanese Unexamined Patent Publication No. 2019-040386

### SUMMARY OF INVENTION

### Technical Problem

However, Patent Literature 1 above describes that the click through rate is predicted on the basis of a display position of an advertisement (for example, arrangement of images) on an advertisement delivery surface, but does not describe that a flow line of a user is taken into account and that a relationship between a plurality of pieces of content included in an advertisement delivered manuscript (hereinafter referred to as a “delivered manuscript”) is considered. Further, the click through rate generally varies depending on a user attribute of an individual user, and Patent Literature 1 does not describe that a click through rate of an individual user is predicted in consideration of a user attribute.

The present disclosure has been made to solve the above problem, and an object of the present disclosure is to accurately predict a click through rate of an individual user while considering a relationship between a plurality of pieces of content included in a delivered manuscript and user attribute information.

### Solution to Problem

The applicant has invented, as a scheme for achieving the above object, a technology for focusing on a graph neural network (GNN), which is a deep learning scheme capable of handling a graph structure, and converting layout information of a delivered manuscript into a graph structure through collation with a flow line of a user using a scheme related to the graph neural network, to accurately predict a click through rate of an individual user as an advertising effect in consideration of a relationship between respective nodes (nodes corresponding to each content included in the delivered manuscript) in the graph structure after conversion and a flow line of a user and using delivery user attribute information.

An advertising effect prediction device according to the present disclosure includes: an acquisition unit configured to acquire delivery user attribute information, delivered manuscript information, and delivery result information; a construction unit configured to convert layout information of a delivered manuscript into a graph structure through collation with a flow line of a user reading the delivered manuscript using a scheme related to a graph neural network on the basis of the delivery user attribute information and the delivered manuscript information, derive a feature quality of each node in the graph structure after conversion, and perform machine learning using the obtained feature quantity of each node and the delivery user attribute information as explanatory variables and a click flag indicating presence or absence of a click of each delivery user obtained from the delivery result information as an objective variable to construct a prediction model for predicting a click through rate of an individual user; and a prediction unit configured to receive a click through rate prediction request of a target user that is a prediction target, target user attribute information, and the delivered manuscript information, convert the layout information of the delivered manuscript into a graph structure through collation with a flow line of the user using the scheme related to a graph neural network on the basis of the target user attribute information and the delivered manuscript information, derive a feature quality of each node in the graph structure after conversion, and input the obtained feature quantity of each node and the target user attribute information to the prediction model, to set a click through rate output from the prediction model as a click through rate prediction value of the individual user related to the target user.

In the advertising effect prediction device, the acquisition unit acquires the delivery user attribute information, the delivered manuscript information, and the delivery result information, and the construction unit converts the layout information of the delivered manuscript into the graph structure through the collation with the flow line of the user reading the delivered manuscript using the scheme related to the graph neural network on the basis of the acquired delivery user attribute information and delivered manuscript information, derives the feature quality of each node in the graph structure after conversion, and performs the machine learning using the obtained feature quantity of each node and the delivery user attribute information as the explanatory variables and a click flag indicating presence or absence of a click of each delivery user obtained from the delivery result information as an objective variable to construct the prediction model for predicting the click through rate of the individual user. The prediction unit receives the click through rate prediction request of the target user that is the prediction target, the target user attribute information, and the delivered manuscript information, converts the layout information of the delivered manuscript into the graph structure through the collation with the flow line of the user using the scheme related to the graph neural network on the basis of the target user attribute information and the delivered manuscript information, derives the feature quality of each node in the graph structure after conversion, and inputs the obtained feature quantity of each node and the target user attribute information to the prediction model, to set a click through rate output from the prediction model as the click through rate prediction value of the individual user related to the target user. Thus, it is possible to accurately predict the click through rate of the individual user as an advertising effect by considering the relationship between the respective nodes (nodes corresponding to each content included in the delivered manuscript) in the graph structure after conversion and the flow line of the user and using the delivery user attribute information by converting the layout information of the delivered manuscript into the graph structure through collation with the flow line of the user using the scheme related to the graph neural network that handles the graph structure, performing the machine learning using the feature quantity of each node in the graph structure after conversion and the delivery user attribute information as the explanatory variables and the click flag indicating the presence or absence of the click of each delivery user as the objective variable to construct the prediction model, and using the constructed prediction model to predict the click through rate of the individual user related to the target user. Further, when the layout information of the delivered manuscript is converted into the graph structure using the scheme related to the graph neural network, it is possible to cope with various layouts, to perform processing with fewer restrictions and a high degree of freedom, and to improve operability and flexibility of the processing since there is a characteristic that data as a conversion target (the layout information of the delivered manuscript) can have a variable length.

### Advantageous Effects of Invention

According to the present disclosure, it is possible to accurately predict the click through rate of an individual user while considering a relationship between a plurality of pieces of content included in a delivered manuscript and user attribute information.

### BRIEF DESCRIPTION OF DRAWINGS

FIG. 1 is a functional block configuration diagram of an advertising effect prediction device according to an embodiment of the invention.

FIG. 2 is a flow diagram illustrating processing content executed in the embodiment of the invention.

FIG. 3 is a diagram illustrating conversion into a graph structure of a delivered manuscript and conversion into a feature quantity of each node.

FIG. 4 is a diagram illustrating an example of data used for processing.

FIG. 5 is a diagram illustrating an example of a hardware configuration of an advertising effect prediction device.

### DESCRIPTION OF EMBODIMENTS

Embodiments of the invention according to the present disclosure will be described with reference to the accompanying drawings.

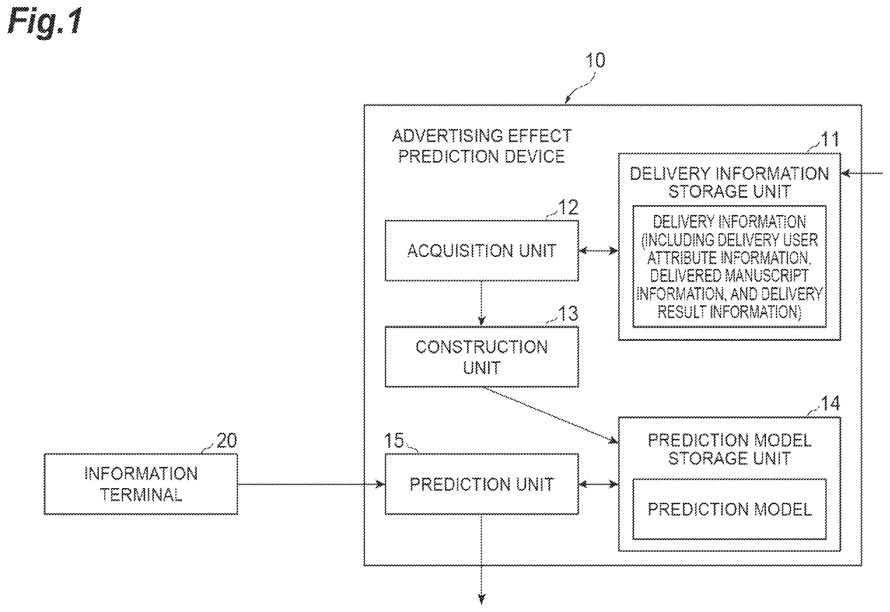

As illustrated in FIG. 1, the advertising effect prediction device 10 includes a delivery information storage unit 11, an acquisition unit 12, a construction unit 13, a prediction model storage unit 14, and a prediction unit 15. Hereinafter, functions of each unit will be described.

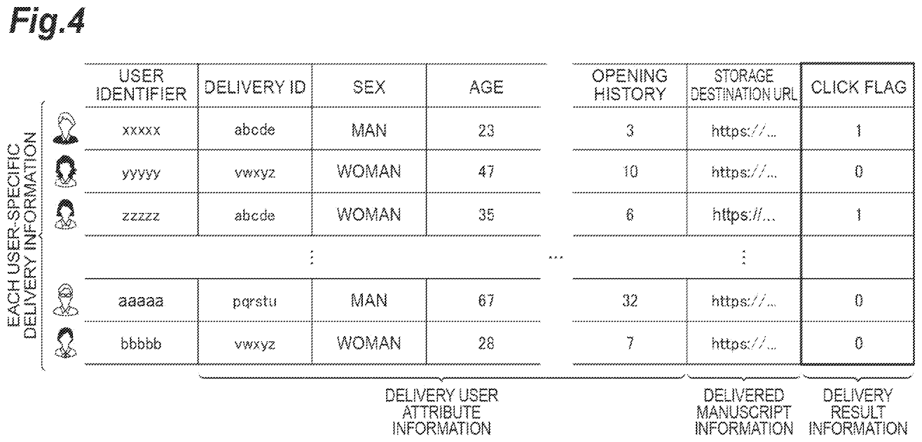

The delivery information storage unit 11 is a database that stores user-specific delivery information including delivery user attribute information, delivered manuscript information, and delivery result information, which will be described below. As illustrated in FIG. 4, the delivery user attribute information includes information such as a sex, age, and an opening history of each delivery user that is a delivery destination of the delivered manuscript, and the delivered manuscript information includes information such as a storage destination uniform resource locator (URL) indicating a storage destination of the delivered manuscript. Delivered manuscript data is stored at a site indicated by the storage destination URL, and this delivered manuscript data includes, for example, content data (image data and text data), and layout information regarding content layout. The delivery result information includes a click flag indicating whether or not each delivery user clicks when reading the delivered manuscript. The delivery user attribute information, the delivered manuscript information, and the delivery result information regarding each delivery user as described above are stored in the delivery information storage unit 11 using a unique user identifier as a key.

The acquisition unit 12 is a functional unit that acquires the delivery user attribute information, the delivered manuscript information, and the delivery result information from the delivery information storage unit 11.

The construction unit 13 is a functional unit that converts the layout information of the delivered manuscript into a graph structure through collation with a flow line of the user reading the delivered manuscript using a scheme related to a graph neural network on the basis of the delivery user attribute information and the delivered manuscript information, derives the feature quality of each node in the graph structure after conversion, and performs machine learning using the obtained feature quantity of each node and the delivery user attribute information as explanatory variables and the click flag indicating presence or absence of a click of each delivery user obtained from the delivery result information as an objective variable to construct a prediction model for predicting the click through rate of an individual user. Details of such processing of the construction unit 13 will be described below.

The prediction model storage unit 14 is a database that stores the prediction model constructed by the construction unit 13.

The prediction unit 15 is a functional unit that receives a click through rate prediction request of a target user that is a prediction target, the target user attribute information, and the delivered manuscript information, converts the layout information of the delivered manuscript into a graph structure through collation with a flow line of the user using the scheme related to the graph neural network on the basis of the target user attribute information and the delivered manuscript information, derives the feature quality of each node in the graph structure after conversion, and inputs the obtained feature quantity of each node and the target user attribute information to the prediction model read from the prediction model storage unit 14, to set the click through rate output from the prediction model as the click through rate prediction value for the individual user related to the target user and output the click through rate (click through rate prediction value) obtained by the prediction. Details of such processing of the prediction unit 15 will be described below. Although an example in which the prediction unit 15 receives the click through rate prediction request of a target user that is a prediction target from the information terminal 20 will be described in the present embodiment, a click through rate prediction request input from an operating terminal (not illustrated) by an operator of the advertising effect prediction device 10 may be received, in addition to this example.

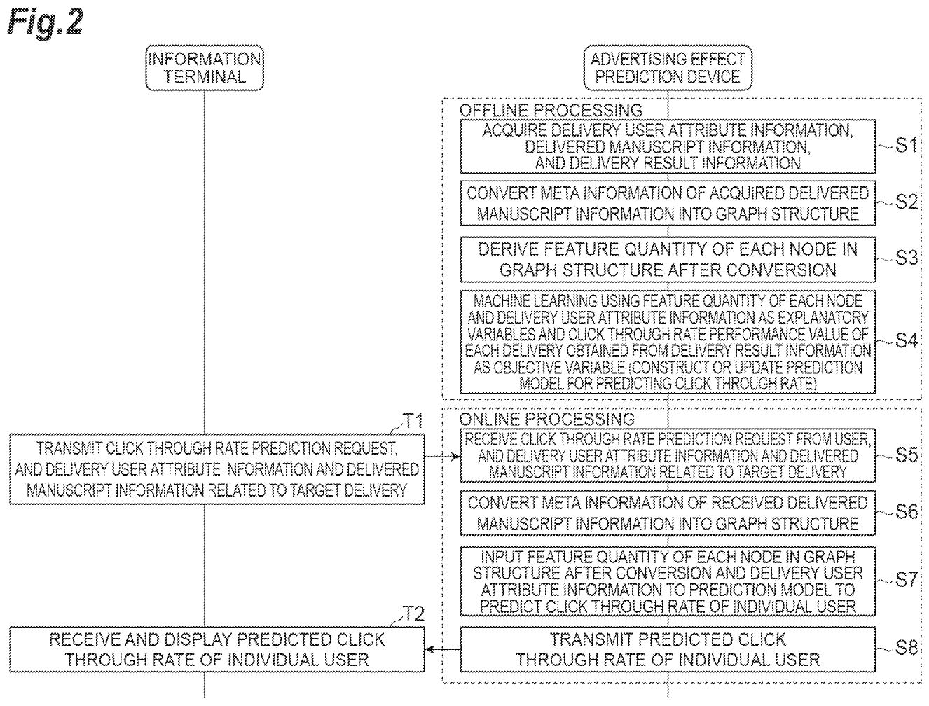

Next, processing executed in the advertising effect prediction device 10 will be described according to a flowchart of FIG. 2. This processing is mainly classified into offline processing for performing constructing and updating of a prediction model in a first half (steps S1 to S4), and online processing for performing click through rate prediction using the prediction model in a second half (steps S5 to S8), as illustrated in FIG. 2. Among these, the offline processing is executed, for example, periodically at a predetermined time or when the operator of the advertising effect prediction device 10 inputs a start command, whereas the online processing is executed on demand when a click through rate prediction request transmitted by a requester of the click through rate prediction (for example, a user of the information terminal 20) is received, as a trigger.

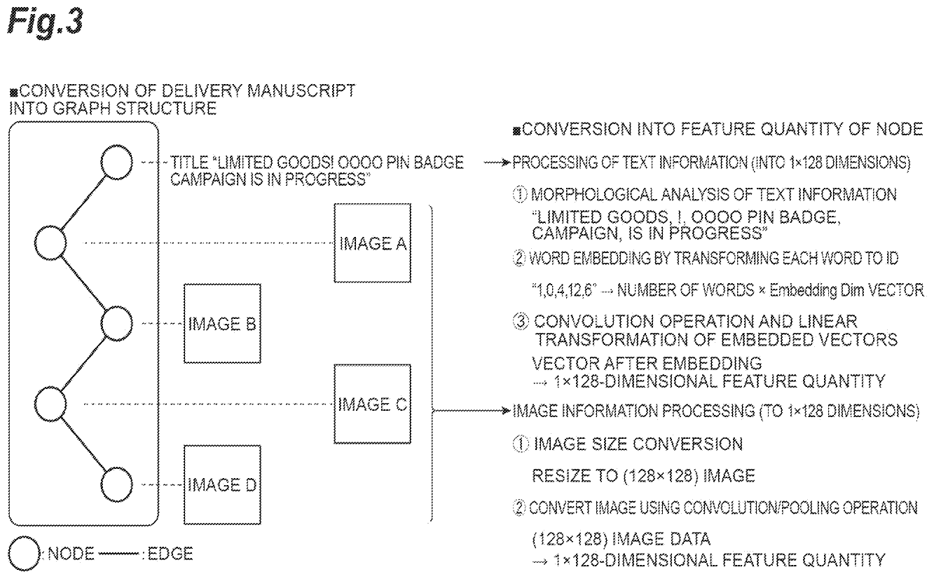

For the first half of the offline processing, the acquisition unit 12 acquires the delivery user attribute information, the delivered manuscript information, and the delivery result information from the delivery information storage unit 11 (step S1), and the construction unit 13 converts meta information of the acquired delivered manuscript information (here, content data included in the delivered manuscript data stored at a site of the storage destination URL illustrated in FIG. 4 (for example, image data, and text information of the email title) and layout information regarding content layout) into a graph structure through collation with a flow line of the user reading the delivered manuscript using a scheme related to a graph neural network (step S2). For example, as shown on the left side of FIG. 3, the email title, and images A to D included in the delivered manuscript are set as nodes in the graph structure, and the nodes are connected to each other with an edge according to the layout information regarding the content layout, so that the meta information of the delivered manuscript information is converted into a graph structure.

Next, the construction unit 13 derives the feature quantity of each node in the graph structure after conversion (step S3). For example, as shown on the right side of FIG. 3, for the text information of the email title, (1) morphological analysis of the text information is performed to separate an email title “Limited goods! OOOO pin badge campaign is in progress” into “Limited goods, !, OOOO pin badge, campaign, and is in progress” for each of words. Next, (2) each word is transformed into an ID and word embedding is performed. For example, the respective separated words are transformed to IDs “1, 0, 4, 12, 6”, and each ID is transformed to a vector of Embedding Dim. Further, (3) convolution calculation and linear transformation are performed on an embedded transformation vector to obtain a 1×128-dimensional feature quantity.

On the other hand, for the image information of the images A to D in FIG. 3, (1) resizing into a (128×128) image is performed as conversion of an image size, and (2) convolution/pooling calculation is performed on the resized (128×128) image, thereby obtaining a 1×128-dimensional feature quantity.

Further, the construction unit 13 performs machine learning using the feature quantity of each node and the delivery user attribute information as explanatory variables and the click flag indicating presence or absence of a click of each delivery user obtained from the delivery result information as an objective variable, to newly construct the prediction model for predicting the click through rate of the individual user or update an existing prediction model (step S4). The construction unit 13 stores the constructed or updated prediction model in the prediction model storage unit 14. Through steps S1 to S4 described above, the prediction model for predicting the click through rate of the individual user is constructed or updated and stored in the prediction model storage unit 14.

Next, in a latter half of the online processing in FIG. 2, the click through rate prediction request, and the target user attribute information and the delivered manuscript information related to the target delivery are transmitted from the information terminal 20 (step T1), and the prediction unit 15 receives the click through rate prediction request, and the target user attribute information and the delivered manuscript information related to the target delivery (step S5) for execution start. The prediction unit 15 converts meta information of the received delivered manuscript information (here, the content data included in the delivered manuscript data stored at the site of the storage destination URL illustrated in FIG. 4 (for example, the image data, and the text information of the email title) and the layout information regarding the content layout) into the graph structure through the collation with the flow line of the user reading the delivered manuscript using the scheme related to the graph neural network in the same scheme as step S2 described above (step S6). For example, as shown on the left side of FIG. 3, the email title, and the images A to D included in the delivered manuscript are set as nodes in the graph structure, and the nodes are connected to each other with an edge according to the layout information regarding the content layout, so that the meta information of the delivered manuscript information is converted into a graph structure.

The prediction unit 15 derives the feature quantity of each node in the graph structure after conversion using the same scheme as in step S3 described above, and inputs the obtained feature quantity of each node and the target user attribute information to the prediction model read from the prediction model storage unit 14, to set the click through rate output from the prediction model as the click through rate prediction value of the individual user related to the target delivery (step S7). Further, the prediction unit 15 transmits the click through rate (click through rate prediction value) of the individual user obtained by the prediction to the information terminal 20 that is a transmission source for the click through rate prediction request (step S8). Accordingly, the click through rate prediction value of the individual user regarding the target user is received by the information terminal 20 and displayed, for example, on the display (step T2), and the user of the information terminal 20 can confirm the click through rate prediction value, as requested.

According to the above-described embodiment, it is possible to accurately predict the click through rate of the individual user as an advertising effect by taking the flow line of the user into account and considering a relationship between a plurality of pieces of content included in the delivered manuscript and using the user attribute information. Further, when the layout information of the delivered manuscript is converted into the graph structure using the scheme related to the graph neural network, it is possible to cope with various layouts, to perform processing with fewer restrictions and a high degree of freedom, and to improve operability and flexibility of the processing since there is a characteristic that data as a conversion target (the layout information of the delivered manuscript) can have a variable length.

In the embodiment, an example in which the construction unit 13 and the prediction unit 15 set text information regarding a title (email title) of the delivered manuscript illustrated in FIG. 3 and image information included in the delivered manuscript, which are minimum necessary content that induces the user to perform a click action, as a target of conversion into a graph structure and derivation of the feature quantity of each node has been described. It is possible to accurately predict the click through rate of the individual user as an advertising effect by setting the text information regarding the title and the image information as the target of the conversion into the graph structure and the derivation of the feature quantity of each node to narrow down the targets to a minimum, and then, taking the flow line of the user into account and considering a relationship between a plurality of pieces of content included in the delivered manuscript.

The construction unit 13 and the prediction unit 15 may set main text information included in the delivered manuscript as the target of the conversion into the graph structure and the derivation of the feature quantity of each node. In this case, the conversion into the graph structure and the derivation of the feature quantity of each node may be executed for the main text information using the same scheme as the text information regarding the title (email title) of the delivered manuscript described above. In fact, since a user's reading of main text is sufficiently likely to lead to a click action, main text information is also set as a target, thereby improving the accuracy of prediction of the click through rate of the individual user.

Further, in the embodiment, an example in which the advertising effect prediction device 10 includes the delivery information storage unit 11 that stores the delivery user attribute information, the delivered manuscript information, and the delivery result information, and the acquisition unit 12 acquires the delivery user attribute information, the delivered manuscript information, and the delivery result information from the delivery information storage unit 11 instead of acquisition from the outside has been described. Thus, since the advertising effect prediction device 10 includes the delivery information storage unit 11 therein, it is not necessary to acquire the delivery user attribute information, the delivered manuscript information, and the delivery result information from the outside at the time of execution of the processing illustrated in FIG. 2, which can contribute to fast processing.

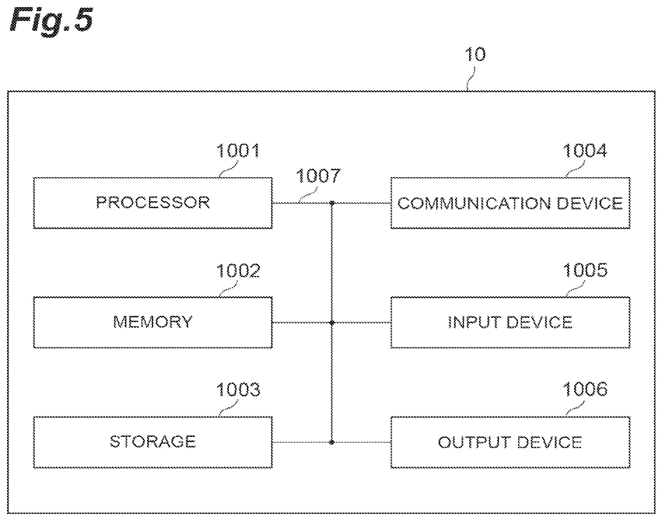

### (Description of Terms, Description of Hardware Configuration (FIG. 5), and the Like)

Block diagrams used to describe the embodiments, and modification examples show blocks on a per-function basis. Functional blocks (components) thereof are realized by any combination of at least one of hardware and software. Further, a method of realizing the respective functional blocks is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but the present disclosure is not limited thereto. For example, a functional block (component) that causes transmission to function is called a transmitting unit or transmitter. In either case, a realization method is not particularly limited, as described above.

For example, the advertising effect prediction device in the embodiment of the present disclosure may function as a computer that performs the processing in the present embodiment. FIG. 5 is a diagram illustrating an example of a hardware configuration of the advertising effect prediction device 10 according to the embodiment of the present disclosure. The advertising effect prediction device described above may be physically configured as a computer device including a processor 1001, a memory 1002, a storage 1003, a communication device 1004, an input device 1005, an output device 1006, a bus 1007, and the like.

In the following description, the term “device” can be read as a circuit, a device, a unit, or the like. A hardware configuration of the advertising effect prediction device 10 may be configured to include one or a plurality of devices illustrated in the figure, or may be configured not to include some of the devices.

Each function of the advertising effect prediction device 10 is realized by loading predetermined software (program) into hardware such as the processor 1001 or the memory 1002 so that the processor 1001 performs calculation to control communication that is performed by the communication device 1004 or control at least one of reading and writing of data in the memory 1002 and the storage 1003.

The processor 1001, for example, operates an operating system to control the entire computer. The processor 1001 may be configured of a central processing unit (CPU) including an interface with peripheral devices, a control device, a calculation device, a register, and the like. Further, the processor 1001 reads a program (program code), a software module, data, or the like from at least one of the storage 1003 and the communication device 1004 into the memory 1002 and executes various processing according to the program, the software module, the data, or the like. As the program, a program for causing the computer to execute at least some of the operations described in the above-described embodiment may be used. Although the case in which the various processing described above are executed by one processor 1001 has been described, the processing may be executed simultaneously or sequentially by two or more processors 1001. The processor 1001 may be implemented by one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), a software module, or the like that can be executed to perform implement a wireless communication method according to an embodiment of the present disclosure.

The storage 1003 is a computer-readable recording medium and may be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The above-described storage medium may be, for example, a database including at least one of the memory 1002 and the storage 1003, or any other appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel). Further, each device such as the processor 1001 and the memory 1002 is connected by the bus 1007 for communicating information. The bus 1007 may be configured by using a single bus, or may be configured by using a different bus for each device.

Each aspect/embodiment described in the present disclosure may be used alone, may be used in combination, or may be used by being switched according to the execution. Further, a notification of predetermined information (for example, a notification of “being X”) is not limited to being made explicitly, and may be made implicitly (for example, the notification of the predetermined information is not made).

Although the present disclosure has been described above in detail, it is obvious to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for illustrative description, and does not have any restrictive meaning with respect to the present disclosure.

A processing procedure, a sequence, a flowchart, and the like in each aspect/embodiment described in the present disclosure may be in a different order unless inconsistency arises. For example, for the method described in the present disclosure, elements of various steps are presented in an exemplary order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

The description “based on” used in the present disclosure does not mean “based only on” unless otherwise noted. In other words, the description “based on” means both of “based only on” and “at least based on”.

When “include”, “including” and variations thereof are used in the present disclosure, these terms are intended to be comprehensive like the term “comprising”. Further, the term “or” used in the present disclosure is intended not to be an exclusive OR.

In the present disclosure, for example, when an article such as a, an, and the in English is added by translation, the present disclosure may include that a noun following such an article is plural.

In the present disclosure, a sentence “A and B differ” may mean that “A and B are different from each other.” The sentence may mean that “each of A and B is different from C.” Terms such as “separate” and “coupled” may also be construed, similarly to “different.”

### REFERENCE SIGNS LIST

10: Advertising effect prediction device; 11: Delivery information storage unit; 12: Acquisition unit; 13: Construction unit; 14: Prediction model storage unit; 15: Prediction unit; 20: Information terminal; 1001: Processor; 1002: Memory; 1003: Storage; 1004: Communication device; 1005: Input device; 1006: Output device; 1007: Bus.

1. An advertising effect prediction device comprising:
an acquisition unit configured to acquire delivery user attribute information, delivered manuscript information, and delivery result information;
a construction unit configured to convert layout information of a delivered manuscript into a graph structure through collation with a flow line of a user reading the delivered manuscript using a scheme related to a graph neural network on the basis of the delivery user attribute information and the delivered manuscript information, derive a feature quality of each node in the graph structure after conversion, and perform machine learning using the obtained feature quantity of each node and the delivery user attribute information as explanatory variables and a click flag indicating presence or absence of a click of each delivery user obtained from the delivery result information as an objective variable to construct a prediction model for predicting a click through rate of an individual user; and
a prediction unit configured to receive a click through rate prediction request of a target user that is a prediction target, target user attribute information, and the delivered manuscript information, convert the layout information of the delivered manuscript into a graph structure through collation with a flow line of the user using the scheme related to a graph neural network on the basis of the target user attribute information and the delivered manuscript information, derive a feature quality of each node in the graph structure after conversion, and input the obtained feature quantity of each node and the target user attribute information to the prediction model, to set a click through rate output from the prediction model as a click through rate prediction value of the individual user related to the target user.

2. The advertising effect prediction device according to claim 1, wherein the prediction unit outputs a click through rate prediction value of the individual user related to the target user to a transmission source for the click through rate prediction request.

3. The advertising effect prediction device according to claim 1, wherein the construction unit and the prediction unit set at least text information regarding a title of the delivered manuscript and image information included in the delivered manuscript as a target of conversion into a graph structure and derivation of a feature quantity of each node.

4. The advertising effect prediction device according to claim 3, wherein the construction unit and the prediction unit set main text information included in the delivered manuscript as the target of conversion into the graph structure and the derivation of the feature quantity of each node.

5. The advertising effect prediction device according to claim 1, further comprising:
a delivery information storage unit configured to store the delivery user attribute information, the delivered manuscript information, and the delivery result information,
wherein the acquisition unit acquires the delivery user attribute information, the delivered manuscript information, and the delivery result information from the delivery information storage unit.

6. The advertising effect prediction device according to claim 2, wherein the construction unit and the prediction unit set at least text information regarding a title of the delivered manuscript and image information included in the delivered manuscript as a target of conversion into a graph structure and derivation of a feature quantity of each node.
